(19) United States
(12) Patent Application Publication
(10) Pub. No.: US 2004/0085017 A1
(43) Pub. Date: May 6, 2004

(54) Variable LED display panel

(76) Inventor: Han-Ming Lee, Taipei City (TW)

Correspondence Address: LEE, HAN-MING, P.O. BOX 7-820, TAIPEI, TW

(21) Appl. No.: 10/285,897

(22) Filed: Nov. 5, 2002

(51) Int. Cl. H05B 33/00

(52) U.S. Cl. 313/506

(57) ABSTRACT

The present invention relates to a variable LED display panel, comprising a cover, a baseboard, an electrically conductive terminal plate, a pad, a LED, and an IC control box, wherein an anode and a cathode are separated with an appropriate distance apart by the pad in the electrically conductive terminal plate at the layer of the cover and the baseboard, and the anode and cathode insert holes of the terminal plates on the top and at the bottom are interlaced. Each hole in the electrically conductive terminal plate is extended integrally as a whole piece out of the sheathing section and securely engaged into the supporting leg. The cover is placed in the fixing groove of the LED bulb, and an embedding hole is disposed on the surface of the groove corresponsive to the insert pipe that passes through the embedding hole to facilitate the LED to be placed into the fixing groove while tightening the sheathing tube to be embedded into the supporting leg, such that the anode terminal plate at the upper section for regular electric conduction for the power supply. The cathode on the lower section of the two plates is switched to drive the chip in the LED to change the single color, double color, or mixed color display with the position of the holes for the selective effects of text, graphic or blinking display.

### BACKGROUND OF THE INVENTION

1. Field of the Invention

The present invention relates to a variable LED display panel, comprising a cover, a baseboard, an electrically conductive terminal plate, a pad, a LED, and an IC control box, wherein the pad separates the electrically conductive terminal plate at the layer of the cover and the baseboard into an anode and a cathode with an appropriate distance apart, and the anode and cathode insert holes of the terminal plates on top and at the bottom are interlaced. Each hole in the electrically conductive terminal plate is extended integrally as a whole piece out of the sheathing section and securely engaged into the supporting leg. The cover is placed in the fixing groove of the LED bulb, and an embedding hole is disposed on the surface of the groove corresponsive to the insert pipe that passes through the embedding hole to facilitate the LED to be placed into the fixing groove while tightening the sheathing tube to be embedded into the supporting leg, such that the anode terminal plate on top for regular electric conduction for the power supply. The cathode at the bottom of the two plates is switched to drive the chip in the LED to change the single color, double color, or mixed color display with the position of the holes for the selective effects of text, graphic or blinking display.

2. Description of the Prior Art

The advertising light panel is used at night, giving an impressive image to our eyes. There are all kinds of wonderful light panels applied for the nighttime, however their use is totally limited by the actual situation of the disposition of the internal light bulb and the energy-saving LED bulb. Since the traditional assembly of the external glass chassis is cumbersome, it is common for the glass panel to fall off and cause accidents. Further, the advertising light panel makes use of the luminance of the fluorescent lamps for the panel display, and requires lots of space for placing the fluorescent lamps. Therefore, the volume of the box and frame will be large and thick, which constitutes an obstacle for pedestrians and motor vehicles; more particularly, the power consumption of the light bulbs is one of the major shortcomings. The common LED light bulb is limited to the single color in the chip and the electric conduction of the positive and negative charge pins, and thus it is limited to each color and the corresponsive bulb for the illumination that causes the single color movement of the electrically conductive plate and the LED bulb. It is unable to adjust the color for lively display or put the multimedia panel into full play, and thus greatly reduces the multiple functions and economic effect.

### SUMMARY OF THE INVENTION

The primary objective of the present invention is to provide a variable LED display panel, particularly the one comprising a cover, a baseboard, an electrically conductive terminal plate, a pad, a LED, and an IC control box; its operation switches the cathode at the lower section of the two plates to drive the chip in the LED and change the single color, double color, or mixed color display with the position of the holes for the selective effects of text, graphic or blinking display.

The secondary objective of the present invention is to provide a variable LED display panel, particularly the one with an anode and a cathode being separated with an appropriate distance apart by the pad in the electrically conductive terminal plate at the layer of the cover and the baseboard, and the anode and cathode insert holes of the terminal plates on the top and at the bottom are interlaced.

Another objective of the present invention is to provide a variable LED display panel, particularly the one with each hole in the electrically conductive terminal plate being extended integrally as a whole piece out of the sheathing section and securely engaged into the supporting leg.

A further objective of the present invention is to provide a variable LED display panel, wherein the cover is placed in a fixing groove of the LED bulb, and an embedding hole is disposed on the surface of the groove corresponsive to the insert pipe that passes through the embedding hole to facilitate the LED to be placed into the fixing groove while tightening the sheathing tube to be embedded into the supporting leg.

### BRIEF DESCRIPTION OF THE DRAWINGS

FIG. 1 is an illustrative diagram of the variable LED display panel of the present invention;

FIG. 2 is an assembled diagram of the variable LED display panel of a preferred embodiment of the present invention;

FIG. 3 is a cross-sectional diagram of the variable LED display panel assembly structure of the present invention;

FIG. 4 is a functional block diagram showing the electrically conductive plate driving the LED chip for single color, double color, or mixed color display according to a preferred embodiment of the present invention;

FIG. 5 is a functional block diagram showing the circuit of the chip controller for making the change of terminal plate according to the present invention.

### DELTAILED DESCRIPTION OF THE PREFERRED EMBODIMENT

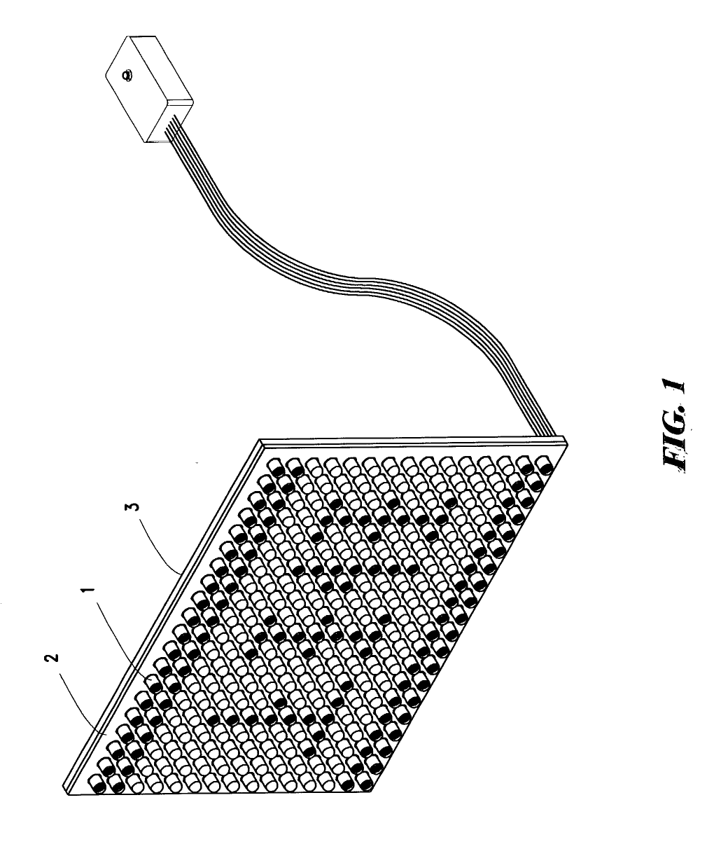

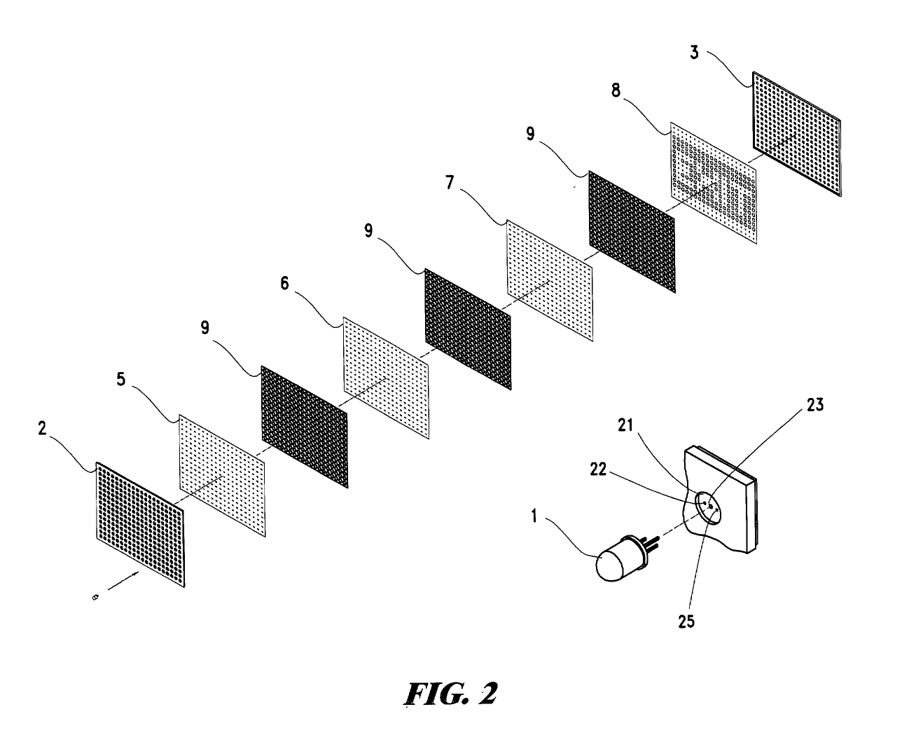

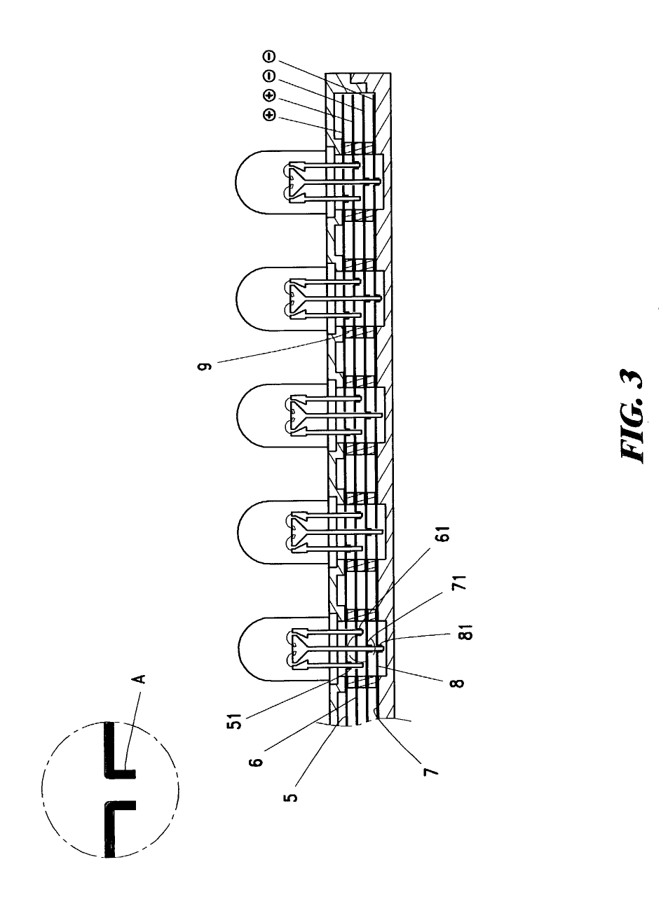

Please refer to FIGS. 1 to 5. The present invention relates to a variable LED display panel, comprising a cover, a baseboard, an electrically conductive terminal plate, a pad, a LED, and an IC control box; wherein the cover 2 comprising a fixed LED bulb fixing groove 21 at the upper frame of the panel, three holes 22, 23, 25 for embedment and engagement such that the insert holes of the cover and the electrically conductive terminal plates are aligned as an integral piece. The assembly of the cover and the baseboard 3 forms an accommodating space and stacks the electrically conductive terminal plates 5, 6, 7, 8 in sequence. The first electrically conductive terminal plate has an insert hole 51 for an anode supporting leg on the side of the LED, and the second electrically conductive terminal plate has an insert hole 61 for the anode supporting leg on the side of the LED, which is the hole for switching the two anodes of the electrically conductive plates on the top and at the bottom. The third electrically conductive terminal plate is a cathode insert hole 71 located between the two pins on both sides of the bulb and the fourth electrically conductive terminal plate is a cathode insert hole 81 located in the middle having the anode of the first and the second electrically conductive terminal plates on top, and the cathode of the third and the fourth electrically conductive terminal plates at the bottom to form a stacked layer such that the insert hole of each terminal plate is interlaced. Each hole in the electrically conductive terminal plate is extended integrally as a whole piece out of the sheathing section A and securely engaged into the supporting leg. The cover is placed in the fixing groove of the LED bulb, and a plastic pad 9 is disposed at the sheathing section of each stacked conductive terminal plate in order to keep the terminal plates apart and prevent them from being short circuited.

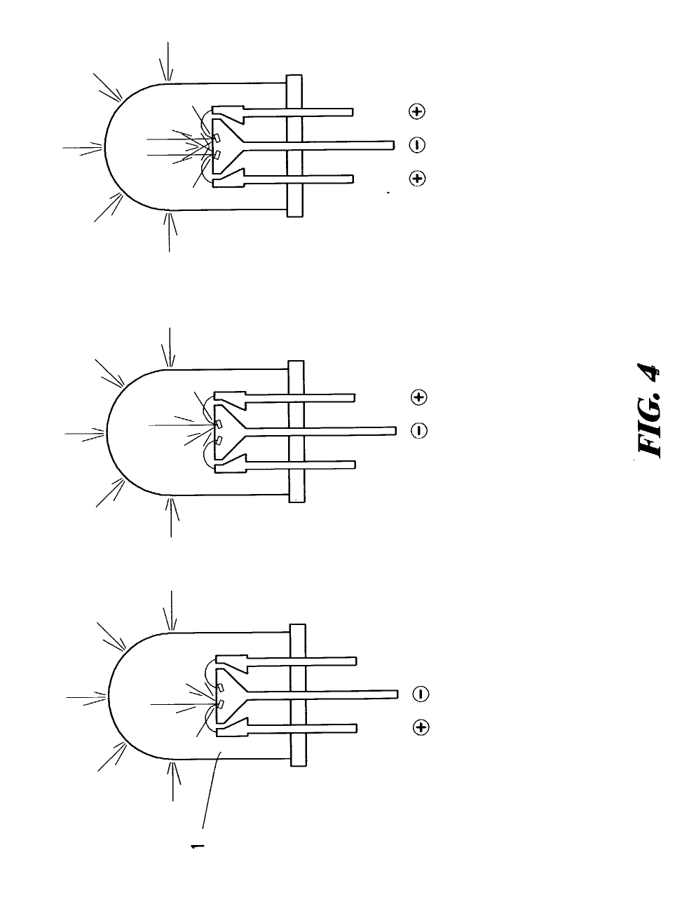

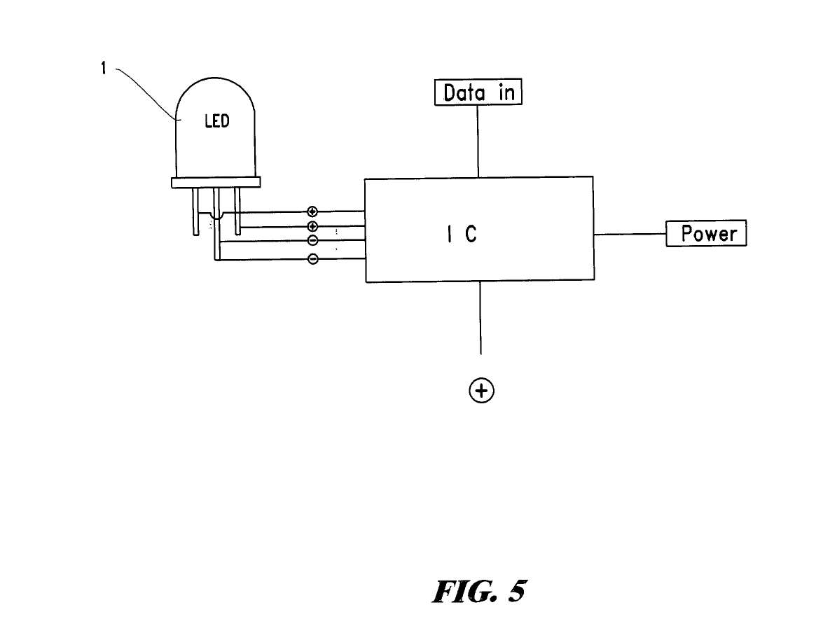

The operation of the present invention makes use of three supporting legs of the LED bulb to align at the three holes for the embedment into the fixing base for secure positioning, so that two legs on both sides of the bulb can be inserted into the left and right sides of the first and second conductive terminal plates, and the longer leg in the middle can be deeply implanted into the cathode of the third and the fourth terminal plates as shown in FIGS. 4 and 5. The connection of the external IC control box B and the stacked layer in the cover drives the first and second conductive terminal plates to illuminate the single color or double color display of the LED by the chip, and the switch of cathode of the third and fourth cathode conductive terminal plate drives each of the aforementioned color to generate a variable mixed color light source, so that the LED panel can have special selective effect for the text, graphic or blinking display.

While the invention has been described by means of specific embodiments, numerous modifications and variations could be made thereto by those skilled in the art without departing from the scope and spirit of the invention set forth in the claims.

What is claimed is:

1. A variable LED display panel, comprising: a cover, a baseboard, an electrically conductive terminal plate, a pad, a LED, and an IC control box; characterized in that the cover comprising three holes in a fixing groove of a LED bulb base on the cover, and the cover with the baseboard forming an accommodating space for stacking a plurality of electrically conductive terminal plates in sequence into a layer;
the first electrically conductive terminal plate having an anode pin insert hole on a side of the LED, and the second electrically conductive terminal plate having an anode pin insert hole on a side of the LED, so that the two insert holes at the top and the bottom being the same anode insert hole for switching the unidirectional terminal plate; the third electrically conductive terminal plate being a cathode insert hole disposed between the two pins on both sides of the bulb and the fourth electrically conductive terminal plate being a cathode insert hole disposed in the middle, having the anode of the first and the second electrically conductive terminal plates on top, and the cathode of the third and the fourth electrically conductive terminal plates at the bottom to form a stacked layer such that the insert hole of each terminal plate being interlaced; each hole in the electrically conductive terminal plate being extended integrally as a whole piece out of a sheathing section and securely engaged into the supporting leg by the LED supporting leg; a plastic pad being disposed at the sheathing section of each stacked conductive terminal plate in order to keep the terminal plates apart and prevent them from being short circuited.
